(19) United States
(12) Patent Application Publication
(10) Pub. No.: US 2025/0047441 A1
(43) Pub. Date: Feb. 6, 2025

(54) PHASE TRACKING REFERENCE SIGNAL CONFIGURATION FOR SINGLE-CARRIER WAVEFORMS

(71) Applicant: Nokia Technologies Oy, Espoo (FI)

(72) Inventors: Oskari TERVO, Oulu (FI); Esa Tapani TIIROLA, Oulu (FI)

(21) Appl. No.: 18/717,504

(22) PCT Filed: Dec. 17, 2021
(86) PCT No.: PCT/EP2021/086368

§ 371 Date: Jun. 7, 2024

(51) Int. Cl. H04L 5/00; H04L 1/00; H04L 27/26

(52) U.S. Cl. CPC H04L 5/0051; H04L 1/0003; H04L 27/2613; H04L 27/2636

(57) ABSTRACT

A Phase Tracking Reference Signal (PTRS) configuration for signal-carrier waveforms (e.g., Known Tail Discrete Fourier Transform (DFT) spread Orthogonal Frequency Division Multiplexing (KT-DFT-s-OFDM) or Single Carrier Frequency Domain Equalization (SC-FDE) waveforms) used in a communication network. For this purpose, a configurable-length sequence of modulation symbols is added in the beginning and end of each single-carrier waveform symbol. One or more sequences of modulation symbols are reported to a User Equipment (UE) from a network node. The PTRS configuration is defined at the UE based on the sequence length(s) and indicative of how PTRS mapping is to be performed within each single-carrier waveform symbol. The UE may then perform communications with the network node using the PTRS configuration. With such PTRS configuration, it is possible to efficiently perform phase noise detection and compensation.

### TECHNICAL FIELD

The present disclosure relates generally to the field of wireless communications, and particularly to techniques for determining a Phase Tracking Reference Signal (PTRS) configuration in case of using single-carrier waveforms in a communication network.

### BACKGROUND

The frequencies beyond 52.6 GHz (which is part of the so-called millimeter wave (mmWave) band or sub-THz band) contain very large spectrum opportunities and will thus facilitate many high-capacity use cases, such as Integrated Access and Backhaul (IAB), Ultra-Reliable Low-Latency Communication (URLLC), massive Machine Type Communication (mMTC), and Internet-of-Things (IoT) applications. However, operation at these higher frequencies has many differences compared to lower frequencies. For example, one of the important implementation challenges at the higher frequencies is an oscillator phase noise (PN) occurring on each of receiving and transmitting sides.

In the next generation of radio access technology specified by the 3rd Generation Partnership Project (3GPP) as New Radio (NR), Reference Signals (RSs) for tracking the oscillator PN, also referred to as Phase Tracking RSs (PTRSs), have been studied for wireless communications at the frequencies beyond 52.6 GHz. More specifically, 3GPP Release 17 (Rel-17) provides support for frequencies ranging from 52.6 GHz to 71 GHz by using single-carrier Cyclic Prefix (CP)-Discrete Fourier Transform (DFT) spread Orthogonal Frequency Division Multiplexing (CP-DFT-s-OFDM) in an uplink. Single-carrier waveforms are promising since they are very robust to the PN, employing low-complexity time-domain PN compensation. In 3GPP Rel-19 and beyond, going to even higher frequencies above 71 GHz may be under discussion. Thus, the PN and the PTRS design will be one of the key topics in the nearest future due to the significantly increased PN problem at the higher frequencies. Another important design aspect to consider at the frequencies above 71 GHz is a waveform. Already in 3GPP Rel-18 discussions, it has been proposed to consider new single-carrier waveforms when going above 71 GHz. Especially interesting candidates are single-carrier waveforms without a CP, such as Known Tail (KT)-DFT-s-OFDM (KT-DFT-s-OFDM) (also known as Unique Word (UW) DFT-s-OFDM), in which the CP of DFT-s-OFDM is replaced with some head and/or tail sequences of modulation symbols in the beginning and end of each single-carrier waveform symbol. Such head and/or tail sequence is inserted prior to a DFT block in a transmitter. Another waveform candidate may be, e.g., obtained by means of Single Carrier Frequency Domain Equalization (SC-FDE), which is employed, e.g., in IEEE 802.11ad standard. SC-FDE does not employ DFT or IFFT operations in the transmitter, but uses a fixed sequence in the beginning of each single carrier block of symbols.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables efficient PTRS configuration for single-carrier waveforms in a communication network.

The objective above is achieved by the features of the independent claims in the appended claims. Further embodiments and examples are apparent from the dependent claims, the detailed description and the accompanying drawings.

According to a first aspect, a User Equipment (UE) in a communication network is provided. The UE comprises at least one processor and at least one memory. The at least one memory comprises a computer program code. The at least one memory and the computer program code are configured to, with the at least one processor, cause the UE to operate at least as follows. At first, the UE is caused to receive, from a network node, information that is indicative of: (i) a head sequence of modulation symbols to be appended to a head end of a single-carrier waveform symbol, and (ii) a tail sequence of modulation symbols to be appended to a tail end of the single-carrier waveform symbol. Then, the UE is caused to use a sequence length of at least one of the head sequence of modulation symbols and the tail sequence of modulation symbols to determine a PTRS configuration that is indicative of how at least one PTRS symbol is to be mapped within the single-carrier waveform symbol. Next, the UE is caused to perform communications with the network node using the PTRS configuration. By so doing, the UE may efficiently map the PTRS symbol(s) within each single-carrier waveform symbol based on the sequence length of at least one of the head and tail sequences of modulation symbols (which may be represented, e.g., by Zadoff-Chu or pi/2-Binary Phase Shift Keying (BPSK) sequences, or any other preferably low Peak-to-Average Power Ratio (PAPR) sequence). This, in turn, may enable efficient PN detection and compensation. Moreover, by properly selecting the sequence length(s), it is possible to provide optimized spectrum efficiency.

In one example embodiment of the first aspect, the at least one memory and the computer program code are configured to, with the at least one processor, cause the UE to receive the information via a dedicated (e.g., a Radio Resource Control (RRC)) signalling. By so doing, it is possible to perform said reception in a UE-specific manner.

In one example embodiment of the first aspect, the PTRS configuration is indicative of: a mapping start point of the at least one PTRS symbol within the single-carrier waveform symbol; and a mapping length of the at least one PTRS symbol within the single-carrier waveform symbol. By using these configuration parameters, it is possible to efficiently map the PTRS symbol(s) within each single-carrier waveform symbol.

In one example embodiment of the first aspect, the at least one memory and the computer program code are configured to, with the at least one processor, cause the UE to:
determine the mapping start point of the at least one PTRS symbol based on the sequence length of the head sequence of modulation symbols and determine the mapping length of the at least one PTRS symbol based on the sequence length of the tail sequence of modulation symbols; or
determine the mapping start point of the at least one PTRS symbol based on the sequence length of the tail sequence of modulation symbols and determine the mapping length of the at least one PTRS symbol based on the sequence length of the head sequence of modulation symbols.

By using the head and tail sequences of modulation symbols in this manner, the UE may obtain a wide diversity of PTRS configurations, thereby increasing its flexibility-in-use and enabling optimized performance with efficient PTRS configurations.

In one example embodiment of the first aspect, the at least one memory and the computer program code are configured to, with the at least one processor, cause the UE to determine the mapping start point and the mapping length according to at least one of the following criteria:
the bigger the sequence length of the head sequence of modulation symbols, the farther the mapping start point of the at least one PTRS symbol is relative to the head end of the single-carrier waveform symbol; and
the bigger the sequence length of the tail sequence of modulation symbols, the shorter the mapping length of the at least one PTRS symbol.

By so doing, the UE may map the PTRS symbol(s) within each single-carrier waveform symbol more efficiently.

In one example embodiment of the first aspect, the PTRS configuration is indicative of: a number of PTRS groups into which the at least one PTRS symbol is to be divided within the single-carrier waveform symbol; and a number of PTRS symbols in each of the PTRS groups. PTRS symbols are arranged consecutive in time in each of the PTRS groups. By using these configuration parameters in addition to the mapping start point and the mapping length, it is possible to map the PTRS symbol(s) within each single-carrier waveform symbol more efficiently.

In one example embodiment of the first aspect, the at least one memory and the computer program code are configured to, with the at least one processor, cause the UE to determine the number of the PTRS groups according to the following criterion: the bigger the sequence length of at least one of the head sequence of modulation symbols and the tail sequence of the modulation symbols, the smaller the number of the PTRS groups into which the at least one PTRS symbol is to be divided within the single-carrier waveform symbol. By so doing, the UE may properly divide the PTRS symbols into the PTRS groups, thereby leading to more efficient PTRS mapping within each single-carrier waveform symbol.

In one example embodiment of the first aspect, the at least one memory and the computer program code are configured to, with the at least one processor, cause the UE to determine the PTRS configuration according to at least one of the following criteria:
the bigger the sequence length of the head sequence of modulation symbols, the farther a first PTRS group of the PTRS groups is relative to the head end of the single-carrier waveform symbol; and
the bigger the sequence length of the tail sequence of modulation symbols, the farther a last PTRS group of the PTRS groups is relative to the tail end of the single-carrier waveform signal.

By so doing, the UE may provide a more efficient arrangement of PTRS groups within each single-carrier waveform symbol, thereby leading to more efficient PTRS mapping within each single-carrier waveform symbol.

In one example embodiment of the first aspect, the sequence lengths of the head sequence of modulation symbols and the tail sequence of modulation symbols are equal. By selecting the same sequence length for each of the head and tail sequences of modulation symbols, the UE may obtain a wide diversity of PTRS configurations, thereby increasing its flexibility-in-use.

In one example embodiment of the first aspect, the at least one memory and the computer program code are configured to, with the at least one processor, cause the UE to determine the PTRS configuration additionally based on at least one of: a number of physical resource blocks dedicated to a communication channel established between the UE and the network node; a Modulation and Coding Scheme (MCS) used by the UE for the communications; a symbol length used in the communication channel; and a subcarrier spacing applied for the communication channel. By using this additional information in combination with the sequence lengths, it is possible to provide a wider diversity of PTRS configurations with optimized performance, thereby increasing the flexibility-in-use of the UE according to the first aspect even more.

In one example embodiment of the first aspect, the single-carrier waveform symbol comprises at least one Known Tail (KT) Discrete Fourier Transform (DFT) spread Orthogonal Frequency Division Multiplexing (OFDM) (KT-DFT-s-OFDM) symbol or at least one Single-Carrier Frequency Domain Equalization (SC-FDE) symbol. Each of KT-DFT-s-OFDM and SC-FDE may provide one of the most promising waveform candidates for the frequencies beyond 71 GHz, thereby making the UE according to the first aspect applicable in mmWave or sub-THz scenarios.

In one example embodiment of the first aspect, the at least one memory further comprises a PTRS database that comprises a plurality of database entries. Each of the plurality of database entries is indicative of: (i) a PTRS configuration, and (ii) at least one of a head sequence of modulation symbols and a tail sequence of modulation symbols by which the PTRS configuration is determined. In this example embodiment, the at least one memory and the computer program code are configured to, with the at least one processor, cause the UE to determine the PTRS configuration by selecting the PTRS configuration corresponding to the information from the PTRS database. By so doing, the UE may quickly and efficiently determine the required PTRS configuration.

According to a second aspect, a network node in a communication network is provided. The network node comprises at least one processor and at least one memory. The at least one memory comprises a computer program code. The at least one memory and the computer program code are configured to, with the at least one processor, cause the network node to operate at least as follows. At first, the network node is caused to transmit, to a UE, information that is indicative of: (i) a head sequence of modulation symbols to be appended to a head end of a single-carrier waveform symbol, and (ii) a tail sequence of modulation symbols to be appended to a tail end of the single-carrier waveform symbol. The information causes the UE to determine a PTRS configuration based on a sequence length of at least one of the head sequence of modulation symbols and the tail sequence of modulation symbols. The PTRS configuration is indicative of how at least one PTRS symbol is to be mapped within the single-carrier waveform symbol. After that, the network node is caused to perform communications with the UE using the PTRS configuration. By using such information, the network node may allow the UE to efficiently map the PTRS symbol(s) within each single-carrier waveform symbol. This, in turn, may enable efficient PN detection and compensation at both the UE and the network node. Moreover, by properly selecting the sequence length(s), it is possible to provide optimized spectrum efficiency.

In one example embodiment of the second aspect, the at least one memory and the computer program code are configured to, with the at least one processor, cause the network node to transmit the information via a dedicated (e.g., RRC) signalling. By so doing, it is possible to perform said transmission in a network node-specific manner.

In one example embodiment of the second aspect, the PTRS configuration is indicative of at least one of: a mapping start point of the at least one PTRS symbol within the single-carrier waveform symbol; and a mapping length of the at least one PTRS symbol within the single-carrier waveform symbol. By using these configuration parameters, it is possible to efficiently map the PTRS symbol(s) within each single-carrier waveform symbol.

In one example embodiment of the second aspect, the mapping start point of the at least one PTRS symbol is determined based on the sequence length of the head sequence of modulation symbols and the mapping length of the at least one PTRS symbol is determined based on the sequence length of the tail sequence of modulation symbols. Alternatively, the mapping start point of the at least one PTRS symbol is determined based on the sequence length of the tail sequence of modulation symbols and the mapping length of the at least one PTRS symbol is determined based on the sequence length of the head sequence of modulation symbols. By using the head and tail sequences of modulation symbols in this manner, it is possible to obtain a wide diversity of efficient PTRS configurations, thereby increasing the flexibility-in-use of the network node according to the second aspect and enabling optimized performance with these efficient PTRS configurations.

In one example embodiment of the second aspect, the mapping start point and the mapping length are determined based on at least one of the following criteria:
the bigger the sequence length of the head sequence of modulation symbols, the farther the mapping start point of the at least one PTRS symbol is relative to the head end of the single-carrier waveform symbol; and
the bigger the sequence length of the tail sequence of modulation symbols, the shorter the mapping length of the at least one PTRS symbol.

By so doing, the PTRS symbol(s) may be mapped within each single-carrier waveform symbol more efficiently.

In one example embodiment of the second aspect, the PTRS configuration is indicative of: a number of PTRS groups into which the at least one PTRS symbol is to be divided within the single-carrier waveform symbol; and a number of PTRS symbols in each of the PTRS groups. PTRS symbols are arranged consecutive in time in each of the PTRS groups. By using these configuration parameters in addition to the mapping start point and the mapping length, it is possible to map the PTRS symbol(s) within each single-carrier waveform symbol more efficiently.

In one example embodiment of the second aspect, the number of the PTRS groups is determined according to the following criterion: the bigger the sequence length of at least one of the head sequence of modulation symbols and the tail sequence of the modulation symbols, the smaller the number of the PTRS groups into which the at least one PTRS symbol is to be divided within the single-carrier waveform symbol. By using this criterion, the PTRS symbols may be efficiently divided into the PTRS groups, thereby leading to more efficient PTRS mapping within each single-carrier waveform symbol.

In one example embodiment of the second aspect, the PTRS configuration is determined according to at least one of the following criteria:
the bigger the sequence length of the head sequence of modulation symbols, the farther a first PTRS group of the PTRS groups is relative to the head end of the single-carrier waveform symbol; and
the bigger the sequence length of the tail sequence of modulation symbols, the farther a last PTRS group of the PTRS groups is relative to the tail end of the single-carrier waveform signal.

By using these criteria, it is possible to provide a more efficient arrangement of PTRS groups within each single-carrier waveform symbol, thereby leading to more efficient PTRS mapping within each single-carrier waveform symbol.

In one example embodiment of the second aspect, the sequence lengths of the head sequence of modulation symbols and the tail sequence of modulation symbols are equal. By selecting the same sequence length for each of the head and tail sequences of modulation symbols, it is also possible to obtain a wide diversity of PTRS configurations, thereby increasing the flexibility-in-use of the network node according to the second aspect.

In one example embodiment of the second aspect, the PTRS configuration is additionally determined based on at least one of: a number of physical resource blocks dedicated to a communication channel established between the network node and the UE; an MCS used by the UE for the communications; a symbol length used in the communication channel; and a subcarrier spacing used in the communication channel. By using this additional information in combination with the sequence lengths, it is possible to provide a wider diversity of PTRS configurations with optimized performance, thereby increasing the flexibility-in-use of the network node according to the second aspect even more.

In one example embodiment of the second aspect, the single-carrier waveform symbol comprises at least one KT-DFT-s-OFDM symbol or at least one SC-FDE symbol. Each of KT-DFT-s-OFDM and SC-FDE may provide one of the most promising waveform candidates for frequencies beyond 71 GHZ, thereby making the network node according to the second aspect applicable in mmWave and sub-THz scenarios.

In one example embodiment of the second aspect, the at least one memory further comprises a PTRS database comprising a plurality of database entries. Each of the plurality of database entries is indicative of: (i) a PTRS configuration, and (ii) at least one of a head sequence of modulation symbols and a tail sequence of modulation symbols by which the PTRS configuration is determined. In this example embodiment, the at least one memory and the computer program code are further configured to, with the at least one processor, cause the network node to obtain the information by using the PTRS database. By so doing, the network node may prepare the information quickly and efficiently.

According to a third aspect, a method for operating a UE in a communication network is provided. The method starts with the step of receiving, from a network node, information that is indicative of: (i) a head sequence of modulation symbols to be appended to a head end of a single-carrier waveform symbol, and (ii) a tail sequence of modulation symbols to be appended to a tail end of the single-carrier waveform symbol. The method further proceeds to the step of using a sequence length of at least one of the head sequence of modulation symbols and the tail sequence of modulation symbols to determine a PTRS configuration that is indicative of how at least one PTRS symbol is to be mapped within the single-carrier waveform symbol. Next, the method goes on to the step of performing communications with the network node using the PTRS configuration. By so doing, the UE may efficiently map the PTRS symbol(s) within each single-carrier waveform symbol based on the sequence length of at least one of the head and tail sequences of modulation symbols (which may be represented, e.g., by Zadoff-Chu or pi/2-BPSK sequences, or any other preferably low PAPR sequence). This, in turn, may enable efficient PN detection and compensation. Moreover, by properly selecting the sequence length(s), it is possible to provide optimized spectrum efficiency.

According to a fourth aspect, a method for operating a network node in a communication network is provided. The method starts with the step of transmitting, to a UE, information that is indicative of: (i) a head sequence of modulation symbols to be appended to a head end of a single-carrier waveform symbol, and (ii) a tail sequence of modulation symbols to be appended to a tail end of the single-carrier waveform symbol. The information causes the UE to determine a PTRS configuration based on a sequence length of at least one of the head sequence of modulation symbols and the tail sequence of modulation symbols. The PTRS configuration is indicative of how at least one PTRS symbol is to be mapped within the single-carrier waveform symbol. The method further proceeds to the step of performing communications with the UE using the PTRS configuration. By using such information, the network node may allow the UE to efficiently map the PTRS symbol(s) within each single-carrier waveform symbol. This, in turn, may enable efficient PN detection and compensation at both the UE and the network node. Moreover, by properly selecting the sequence length(s), it is possible to provide optimized spectrum efficiency.

According to a fifth aspect, a computer program product is provided. The computer program product comprises a computer-readable storage medium that stores a computer code. Being executed by at least one processor, the computer code causes the at least one processor to perform the method according to the third aspect. By using such a computer program product, it is possible to simplify the implementation of the method according to the third aspect in any UE, like the UE according to the first aspect.

According to a sixth aspect, a computer program product is provided. The computer program product comprises a computer-readable storage medium that stores a computer code. Being executed by at least one processor, the computer code causes the at least one processor to perform the method according to the fourth aspect. By using such a computer program product, it is possible to simplify the implementation of the method according to the fourth aspect in any network node, like the network node according to the second aspect.

According to a seventh aspect, a UE in a communication network is provided. The UE comprises a means for receiving, from a network node, information that is indicative of: (i) a head sequence of modulation symbols to be appended to a head end of a single-carrier waveform symbol, and (ii) a tail sequence of modulation symbols to be appended to a tail end of the single-carrier waveform symbol. The UE further comprises a means for determining, based on a sequence length of at least one of the head sequence of modulation symbols and the tail sequence of modulation symbols, a PTRS configuration that is indicative of how at least one PTRS symbol is to be mapped within the single-carrier waveform symbol. The UE further comprises a means for performing communications with the network node using the PTRS configuration. By so doing, the UE may efficiently map the PTRS symbol(s) within each single-carrier waveform symbol based on the sequence length of at least one of the head and tail sequences of modulation symbols (which may be represented, e.g., by Zadoff-Chu or pi/2-BPSK sequences, or any other preferably low PAPR sequence). This, in turn, may enable efficient PN detection and compensation. Moreover, by properly selecting the sequence length(s), it is possible to provide optimized spectrum efficiency.

According to an eighth aspect, a network node in a communication network is provided. The network node comprises a means for transmitting, to a UE, information that is indicative of: (i) a head sequence of modulation symbols to be appended to a head end of a single-carrier waveform symbol, and (ii) a tail sequence of modulation symbols to be appended to a tail end of the single-carrier waveform symbol. The information causes the UE to determine a PTRS configuration based on a sequence length of at least one of the head sequence of modulation symbols and the tail sequence of modulation symbols. The PTRS configuration is indicative of how at least one PTRS symbol is to be mapped within the single-carrier waveform symbol. The network node further comprises a means for performing communications with the UE using the PTRS configuration. By using such information, the network node may allow the UE to efficiently map the PTRS symbol(s) within each single-carrier waveform symbol. This, in turn, may enable efficient PN detection and compensation at both the UE and the network node. Moreover, by properly selecting the sequence length(s), it is possible to provide optimized spectrum efficiency.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 schematically shows a symbol structure that is provided by using Discrete Fourier Transform (DFT) spread Orthogonal Frequency Division Multiplexing (DFT-s-OFDM);

FIG. 2 schematically shows a symbol structure that is provided by using Known Tail (KT) DFT-S-OFDM (KT-DFT-s-OFDM);

FIG. 3 shows a block diagram of a UE in accordance with one example embodiment;

FIG. 4 shows a flowchart of a method for operating the UE shown in FIG. 3 in accordance with one example embodiment;

FIG. 5 shows a block diagram of a network node in accordance with one example embodiment;

FIG. 6 shows a flowchart of a method for operating the network node shown in FIG. 5 in accordance with one example embodiment;

FIGS. 7A and 7B show different patterns of Phase Tracking Reference Signal (PTRS) mapping in case of using different lengths of head and tail sequences of modulation symbols; and

FIGS. 8A-8G show the comparative performance results of the legacy DFT-s-OFDM method and the method shown in FIG. 4 at carrier frequency 140 GHZ, using 64 Quadrature Amplitude Modulation (QAM), subcarrier spacings 1920 kHz and 960 kHz, and different KT lengths (8, 16, 32, 64, and 128 symbols).

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication for a UE in a particular communication network. More specifically, the network node is used to connect the UE to a Data Network (DN) through a Core Network (CN) and may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G communication technology (also referred to as New Radio (NR)). The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

In some example embodiments, the UE and the network node may be applicable in different Integrated Access and Backhaul (IAB) scenarios which may be quite important for the sub-THz band. In these example embodiments, the UE functionalities (i.e., backhaul link operation) may be implemented by a Mobile Termination (MT) part of an IAB node, while the network node (e.g., gNB) functionalities (i.e., access link operation) may be implemented by a Distributed Unit (DU) part of the IAB node.

According to the example embodiments disclosed herein, a communication network, in which the UE and the network node may communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

As used in the example embodiments disclosed herein, a Phase Tracking Reference Signal (PTRS) may refer to a reference signal that enables detection and compensation of an oscillator phase noise (PN). The PN usually increases as a function of an oscillator carrier frequency. Therefore, the PTRS may be advantageously utilized at high carrier frequencies, such as those from the mmWave and sub-THz bands, to mitigate the PN. The PTRS may be UE-specific and confined in one or more allocated resource elements or Physical Resource Blocks (PRBs).

It should be also noted that wireless communications between the network node and the UE may be performed by using different types of the OFDM scheme, such as Cyclic Prefix (CP) OFDM, Single Carrier Frequency Division Multiplexing (SC-FDM), Discrete Fourier Transform spread OFDM (DFT-s-OFDM), and Multi-Carrier Code Division Multiplexing (MC-CDM), etc.

3GPP Technical Specification (TS) 38.211 (see Table 6.4.1.2.2.2-1) defines PTRS configurations for the DFT-s-OFDM in an uplink such that PTRSs are inserted in a time domain before DFT (pre-DFT) and there are five different configurations from which the PTRS configuration is chosen according to a scheduled bandwidth (BW) (see Table 6.2.3.2-1 in 3GPP TS 38.214). In this case, the PTRS configuration is generally defined by the following two configuration parameters:
a sample density of PTRS for the DFT-s-OFDM, pre-DFT, indicating a set of thresholds (number of PRBs) T={N_{PRBn}, n=0,1,2,3,4}, which indicates the dependency between the presence of the PTRS and the scheduled BW and values of N_{group}^{PTRS} (a number of PTRS groups) and Nₛₐₘₚ^{group} (a number of samples or, in other words, PTRS symbols per PTRS group) the UE should use depending on the scheduled BW; and
a time density (OFDM symbol level) of the PTRS for the DFT-s-OFDM (if this parameter is absent, the UE may apply value d1, as follows from clause 6.1 of 3GPP TS 38.214).

The PTRS symbols inserted in the time domain as in 5G NR DFT-s-OFDM, enables relatively simple time-domain PN compensation on the receiver side.

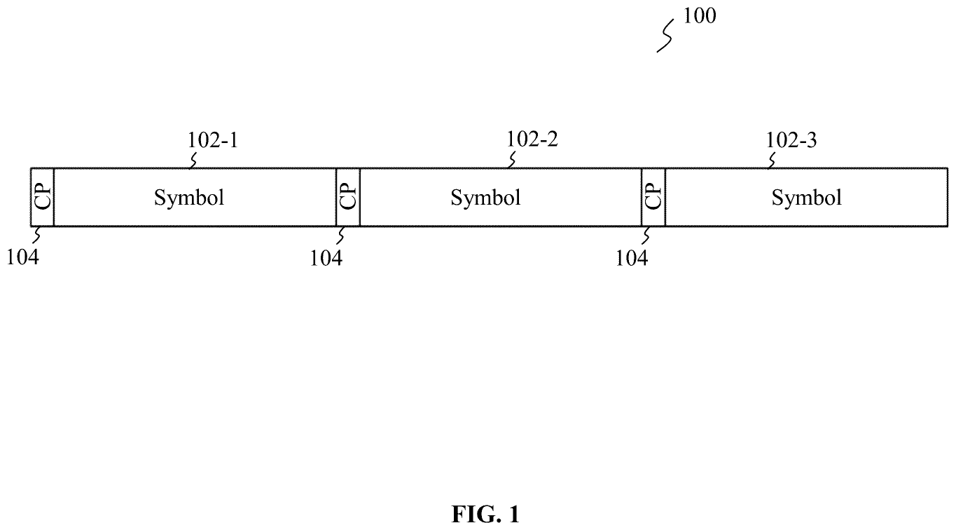

FIG. 1 schematically shows a symbol structure 100 that is provided by using the DFT-s-OFDM. As shown in FIG. 1, the symbol structure 100 comprises three OFDM symbols 102-1, 102-2, 102-3 which are separated by a cyclic prefix (CP) 104. In the DFT-s-OFDM, the CP 104 is used to facilitate inter-symbol-interference-free reception in a frequency selective channel by using a frequency domain equalizer. 5G NR specification supports either normal CP, or extended CP. Each of the OFDM symbols 102-1, 102-2, 102-3 is extended by the CP 104 (after Inverse Fast Fourier Transform (IFFT)). Given the symbol structure 100 and the above-mentioned description of the standardized PTRS configuration, PTRS mapping may be performed within each of the OFDM symbols 102-1, 102-2, 102-3 such that the PTRS mapping starts from the beginning (i.e., a head end) of each OFDM symbol, and the length of the PTRS mapping is equal to the length of the OFDM symbol itself.

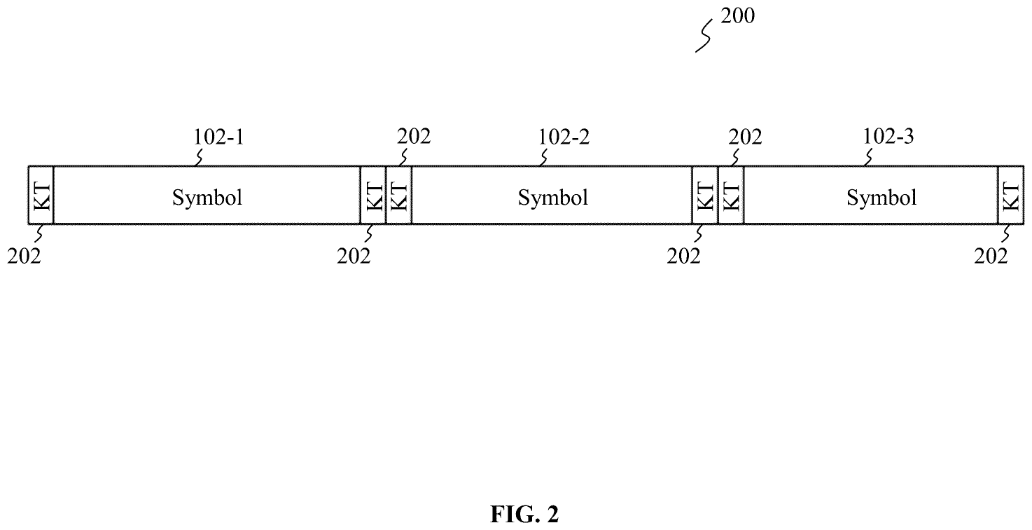

FIG. 2 schematically shows a symbol structure 200 that is provided by using Known Tail (KT) DFT-s-OFDM (KT-DFT-s-OFDM). The KT-DFT-s-OFDM is also referred to as Unique Word (UW-DFT-s-OFDM). It should be noted that the KT-DFT-s-OFDM may provide one of the most promising waveform candidates for the frequencies beyond 71 GHz. The KT-DFT-s-OFDM is quite similar to the DFT-s-OFDM defined for the uplink and also supported by the uplink in 5G NR. However, the main difference is that the DFT-s-OFDM uses the CP 104, while in the KT-DFT-s-OFDM, the CP 104 is replaced by an in-symbol known sequence 202 of modulation symbols (also referred to as the KT sequence) having a configurable sequence length. The KT sequence 202 is appended to head end and tail end of each of the OFDM symbols 102-1, 102-2, 102-3 prior to the DFT operation on the transmitter side. The lengths of the head and tail sequences of modulation symbols may be different or the same, typically such that the length of the head sequence of modulation symbols is bigger than the length of the tail sequence of modulation symbols. In addition, there is no extra guard interval between the OFDM symbols 102-1, 102-2, 102-3. All of this provides many benefits, such as:
the flexibly configurable sequence length provides optimized spectrum efficiency depending on particular applications, without affecting a slot structure as in CP-DFT-s-OFDM or other CP-based waveforms;
the PAPR is reduced, thereby increasing a transmit power;
the PAPR may be further reduced using spectrum shaping techniques, such as Frequency-Domain Spectral Shaping (FDSS) or FDSS with spectrum extension;
15-symbol slots may be used, compared to conventional 14-symbol slots (applied with a normal CP length); and
the KT sequence 202 may be used, e.g., for channel estimation and PN estimation, providing improved operational performance.

The PTRS mapping described above for the symbol structure 100 may not be optimized for the symbol structure 200 because of the presence of the KT sequence 202 in the beginning and end of each of the OFDM symbols 102-1, 102-2, 102-3. In particular, the head and/or tail sequence of modulation symbols may be used for PN compensation in many cases. For this reason, PN compensation capability and optimum PTRS allocation may also depend on the sequence length of the KT sequence 202.

As noted earlier, the PN is pronounced more significantly at higher frequencies, and the current PTRS configurations are designed mostly for OFDM and DFT-s-OFDM waveforms. As for the KT-DFT-s-OFDM, it has not yet been standardized anyhow, and there are still open questions concerning its efficient application, especially at the frequencies corresponding to the mmWave and sub-THz bands.

The example embodiments disclosed herein provide a technical solution that allows mitigating or even eliminating the above-sounded drawbacks peculiar to the prior art. In particular, the technical solution disclosed herein relates to a PTRS configuration for single-carrier waveforms (e.g., KT-DFT-s-OFDM or SC-FDE waveforms, or any variant of those) used in a communication network. For this purpose, a configurable-length sequence of modulation symbols is added in the beginning and end of each single-carrier waveform symbol. One or more sequences of modulation symbols are reported to a UE from a network node. The PTRS configuration is defined at the UE based on the sequence length(s) and indicative of how PTRS mapping is to be performed within each single-carrier waveform symbol. The UE may then perform communications with the network node (i.e., data reception and/or transmission) based on the PTRS configuration. With such PTRS configuration, it is possible to efficiently perform PN detection and compensation. Moreover, the configurable sequence length may provide optimized spectrum efficiency.

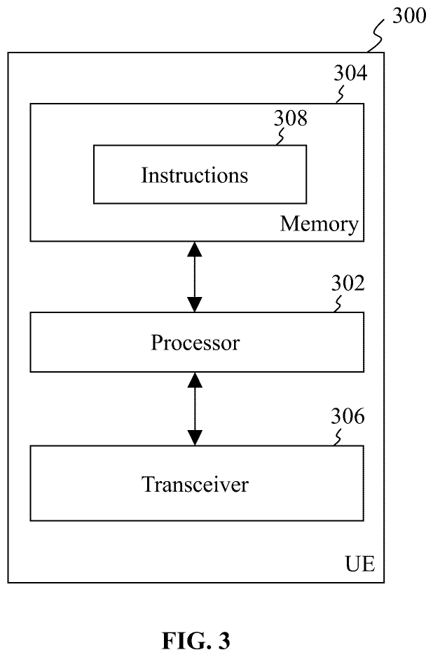

FIG. 3 shows a block diagram of a UE 300 in accordance with one example embodiment. The UE 300 is intended to communicate with one or more network nodes in any of the above-described wireless communication networks. As shown in FIG. 3, the UE 300 comprises a processor 302, a memory 304, and a transceiver 306. The memory 304 stores processor-executable instructions 308 which, when executed by the processor 302, cause the processor 302 to perform the aspects of the present disclosure, as will be described below in more detail. It should be noted that the number, arrangement, and interconnection of the constructive elements constituting the UE 300, which are shown in FIG. 3, are not intended to be any limitation of the present disclosure, but merely used to provide a general idea of how the constructive elements may be implemented within the UE 300. For example, the processor 302 may be replaced with several processors, as well as the memory 304 may be replaced with several removable and/or fixed storage devices, depending on particular applications. Furthermore, in some embodiments, the transceiver 306 may be implemented as two individual devices, with one for a receiving operation and another for a transmitting operation. Irrespective of its implementation, the transceiver 306 is intended to be capable of performing different operations required to perform the data reception and transmission, such, for example, as signal modulation/demodulation, encoding/decoding, etc. In other embodiments, the transceiver 306 may be part of the processor 302 itself.

The processor 302 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 302 may be implemented as any combination of one or more of the aforesaid. As an example, the processor 102 may be a combination of two or more microprocessors.

The memory 304 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 308 stored in the memory 304 may be configured as a computer-executable program code which causes the processor 302 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 304) on the fly.

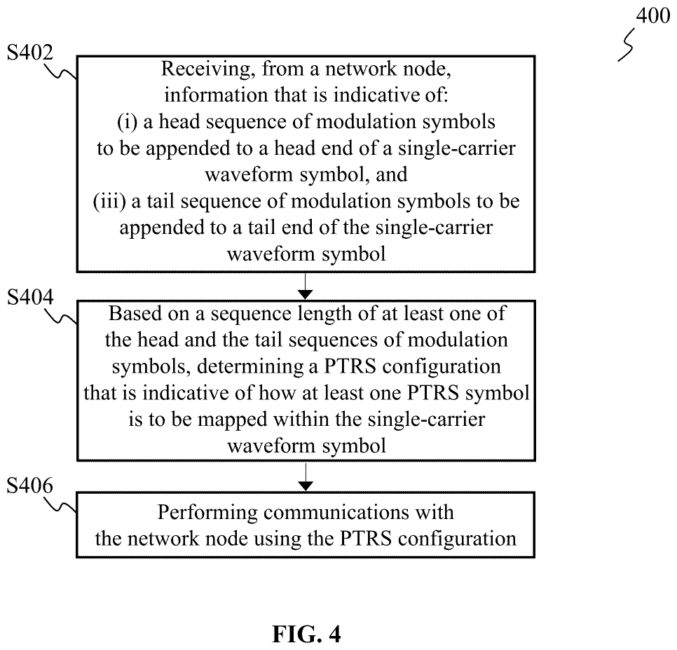

FIG. 4 shows a flowchart of a method 400 for operating the UE 300 in accordance with one example embodiment. Although the method 400 is described below with reference to one single-carrier waveform symbol, those skilled in the art would appreciate that the method 400 may be also applied to a set of single-carrier waveform symbols (in this case, the method 400 may be performed for each of the set of single-carrier waveform symbols in parallel or in sequence).

The method 400 starts with a step S402, in which the processor 302 receives (e.g., via the transceiver 306), from a network node, information that is indicative of: (i) a head sequence of modulation symbols to be appended to a head end of a single-carrier waveform symbol, and (ii) a tail sequence of modulation symbols to be appended to a tail end of the single-carrier symbol. The single-carrier waveform symbol comprises a set of indexed resource elements, and the head end of the single-carrier waveform symbol may refer to a first-indexed resource element, while the tail end of the single-carrier waveform symbol may refer to a last-indexed resource element. In this sense, the head sequence of modulation symbols may refer to a sequence of modulation symbols appended to the first-indexed resource element of the single-carrier waveform symbol (i.e., in the beginning of the single-carrier waveform symbol), while the tail sequence of modulation symbols may refer to a sequence of modulation symbols appended to the last-indexed resource element of the single-carrier waveform symbol (i.e., in the end of the single-carrier waveform symbol). Each of the head sequence of modulation symbols and the tail sequence of modulation symbols has a sequence length expressed as a number of modulation symbols in the sequence or a number of resource elements occupied by the sequence. The head sequence of modulation symbols and/or the tail sequence of modulation symbols may have a configurable sequence length. The single-carrier waveform symbol may comprise at least one KT-DFT-s-OFDM symbol, but the present disclosure is not limited to this type of the single-carrier waveform symbol and any other single-carrier waveform symbols (e.g., SC-FDE symbols) using one or more known sequences of modulation symbols (e.g., complex sequences, such as Zadoff-Chu sequences, or pi/2-BPSK sequences, or any other low-PAPR sequences) may be used depending on particular applications. Moreover, the head and tail sequences of modulation symbols may be of the same or different type, and/or may have the same or different sequence length.

Then, the method 400 proceeds to a step S404, in which the processor 302 uses the sequence length of at least one of the head sequence of modulation symbols and the tail sequence of modulation symbols to determine a PTRS configuration. The PTRS configuration is indicative of how one or more PTRS symbols are to be mapped within the single-carrier waveform symbol.

In some embodiments, the PTRS configuration may indicate at least one of the following: a mapping start point of the at least one PTRS symbol within the single-carrier waveform symbol; and a mapping length of the at least one PTRS symbol within the single-carrier waveform symbol. The mapping start point refers to a resource element (or index) of a single-carrier waveform symbol, from which the mapping of the PTRS configuration is calculated. In other words, the mapping start point implies a distance from the head end of the single-carrier waveform symbol to a first PTRS symbol of the PTRS configuration within the single-carrier waveform symbol, with all (if available) subsequent PTRS symbols being mapped after the first PTRS symbol within the single-carrier waveform symbol. The mapping length refers to a distance at which each of the at least one PTRS symbols is mapped within the single-carrier waveform symbol. It should be noted that, in case of multiple PTRS symbols, they may be mapped either immediately one after another or with a certain inter-PTRS symbol gap within the mapping length. Furthermore, the multiple PTRS symbols may be also divided into PTRS groups which, in turn, may be mapped with a certain inter-group gap within the mapping length. The mapping length is calculated from the mapping start point and may be equal to a part of the single-carrier waveform symbol, which is occupied by the PTRS symbol(s), or to the whole length of the single-carrier waveform symbol (i.e., the PTRS symbols are distributed along the length of the single-carrier waveform symbol).

The processor 302 may determine the mapping start point of the PTRS symbol(s) based on the sequence length of the head sequence of modulation symbols and determine the mapping length of the PTRS symbol(s) based on the sequence length of the tail sequence of modulation symbols. Alternatively, the processor 302 may determine the mapping start point of the PTRS symbol(s) based on the sequence length of the tail sequence of modulation symbols and determine the mapping length of the PTRS symbol(s) based on the sequence length of the head sequence of modulation symbols. Furthermore, the processor 302 may use different rules or criteria when determining the mapping start point and the mapping length. For example, such rules or criteria may look as follows: the bigger the sequence length of the head sequence of modulation symbols, the farther the mapping start point of the PTRS symbol(s) is relative to the head end of the single-carrier waveform symbol; and/or the bigger the sequence length of the tail sequence of modulation symbols, the shorter the mapping length of the PTRS symbol(s) within the single-carrier waveform symbol.

In other example embodiments, in addition to the mapping start point and the mapping length, the PTRS configuration may further indicate: a number of PTRS groups into which the PTRS symbol(s) is (are) to be divided within the single-carrier waveform symbol; and a number of PTRS symbols in each of the PTRS groups. PTRS symbols are arranged consecutive in time in each of the PTRS groups. Again, the processor 302 may determine the number of the PTRS groups according to different rules or criteria. For example, the processor 302 may use the following rule or criterion: the bigger the sequence length of at least one of the head sequence of modulation symbols and the tail sequence of the modulation symbols, the smaller the number of the PTRS groups into which the PTRS symbol(s) is (are) to be divided within the single-carrier waveform symbol. Other possible rules or criteria may look as follows: the bigger the sequence length of the head sequence of modulation symbols, the farther a first PTRS group of the PTRS groups is relative to the head end of the single-carrier waveform symbol; and/or the bigger the sequence length of the tail sequence of modulation symbols, the farther a last PTRS group of the PTRS groups is relative to the tail end of the single-carrier waveform symbol.

Turning back to FIG. 4, after the step S404 is finished, the method 400 goes on to a step S406, in which the processor 302 performs communications (e.g., via the transceiver 306) with the network node using the PTRS configuration. Such communications may imply data reception and/or transmission over a communication channel established between the UE 300 and the network node. Such a communication channel may comprise an uplink channel (e.g., the Physical Uplink Shared Channel (PUSCH)), a downlink channel (e.g., the Physical Downlink Shared Channel (PDSCH)), or their combination.

In one example embodiment, the processor 302 may define the PTRS configuration in the step 404 of the method 400 based on the sequence length(s) in combination with at least one of the following: a number of PRBs dedicated to the communication channel; a MCS used by the UE 300 (e.g., MCS type) for the communications with the network node; a symbol length used in the communication channel (this parameter may be used in case of pure single-carrier waveforms, e.g., SC-FDE waveforms, when there are no subcarriers but the PN rather depends on the symbol length); and a subcarrier spacing applied for the communication channel.

It should be noted that the PTRS configuration may be defined differently for different use scenarios. In general, the PTRS configuration has the following impact to receiver performance:
the more PTRSs, the better detection performance;
the more PTRSs, the higher overhead in the communication network (which leads to a reduced amount of PRBs for data).

Therefore, the optimum amount of PTRSs may vary according to the oscillator implementation (at both the UE 300 and the network node), as well as the MCS or subcarrier spacing involved.

In one example embodiment, the memory 304 may further comprise a PTRS database that comprises a plurality of database entries. Each of the plurality of database entries may indicate: (i) a PTRS configuration, and (ii) at least one of a head sequence of modulation symbols and a tail sequence of modulation symbols by which the PTRS configuration is determined. In this example embodiment, the processor 302 may determine the PTRS configuration by selecting, from the PTRS database, the PTRS configuration corresponding to the information received in the step S302. In other words, the processor 302 may check which of the PTRS configurations indicated in the PTRS database corresponds to the head and tail sequences of modulation symbols indicated in the received information and select such a PTRS configuration for further communications with the network node. The PTRS database may be structured in a tabular form, with each row corresponding to a certain PTRS configuration and each column corresponding to certain head and/or tail sequence of modulation symbols required for obtaining the PTRS configuration. Alternatively, the PTRS database may be configured as a set of tables, with each table being associated with a certain PTRS configuration and certain head and/or tail sequence of modulation symbols required for obtaining the PTRS configuration. The processor 302 may be configured to query and maintain the PTRS database by using any suitable programming language, for example, Structured Query Language (SQL).

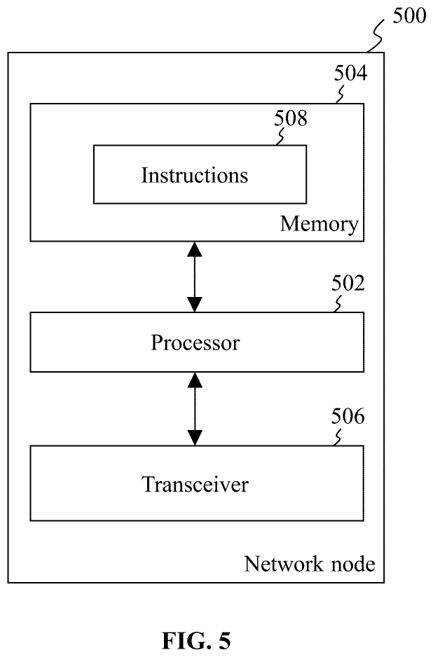

FIG. 5 shows a block diagram of a network node 500 in accordance with one example embodiment. The network node 500 is intended to communicate with the UE 300 in any of the above-described communication networks. As shown in FIG. 5, the network node 500 comprises a processor 502, a memory 504, and a transceiver 506. The memory 504 stores processor-executable instructions 508 which, when executed by the processor 502, cause the processor 502 to implement the aspects of the present disclosure, as will be described below in more detail. It should be again noted that the number, arrangement, and interconnection of the constructive elements constituting the network node 500, which are shown in FIG. 5, are not intended to be any limitation of the present disclosure, but merely used to provide a general idea of how the constructive elements may be implemented within the network node 500. In general, the processor 502, the memory 504, the transceiver 506, and the processor-executable instructions 508 may be implemented in the same or similar manner as the processor 302, the memory 304, the transceiver 306, and the processor-executable instructions 308, respectively.

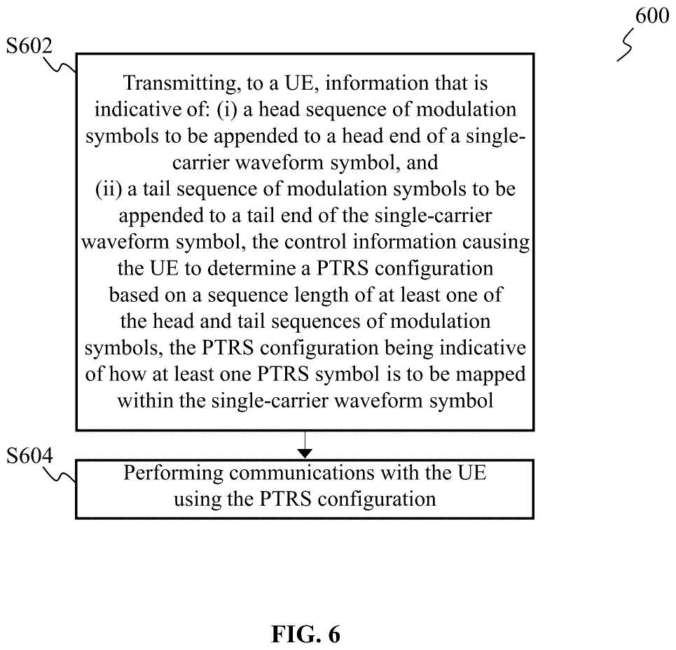

FIG. 6 shows a flowchart of a method 600 for operating the network node 500 in accordance with one example embodiment. The method 600 starts with a step S602, in which the processor 502 transmits (e.g., via the transceiver 506) the above-mentioned information to the UE 300 (i.e., the processor 302). The memory 504 may comprise a PTRS database similar to that stored in the memory 304 of the UE 300, and the processor 502 may obtain such information by using the PTRS database (e.g., the processor 502 may indicate which of the head and tail sequences of modulation symbols to use, the sequence length(s), etc.). The method 600 further proceeds to a step S604, in which the processor 502 performs communications (e.g., over the above-mentioned communication channel) with the UE 300 by using the PTRS configuration corresponding to the transmitted information. As noted above, the PTRS configuration is defined based on the sequence length of at least one of the head sequence of modulation symbols and the tail sequence of modulation symbols. Optionally, information about any of the number of PRBs, the MCS used by the UE 300, the symbol length, and the subcarrier spacing may be also involved to determine the PTRS configuration.

Let us now consider some non-restrictive examples of how to determine the PTRS configuration based on the sequence lengths of the head and tail sequences of modulation symbols each represented by a KT sequence. In these examples, it is assumed that the PTRS mapping is performed within each KT-DFT-s-OFDM symbol and depends on the KT length (the sequence lengths of the KT sequences in the beginning and end of the KT-DFT-s-OFDM symbol are set to be equal for simplicity). It is also assumed that the PTRS symbols are divided into PTRS groups of equal size. The longer the KT length, the higher is the distance between the KT and its closest PTRS group. The mapping start point (or index within each KT-DFT-s-OFDM symbol) and the mapping length will depend on the KT length.

Table 1 below shows the values of the mapping start index and the mapping length depending on different KT lengths (8, 16, and 32 symbols). For simplicity, each example tables given herein assume that the head and tail sequences of modulation symbols have equal lengths. In Table 1, X is the scaling factor (which may be, e.g., 2 by default), and M_sc is the number of allocated subcarriers (e.g., 12*number of PRBs). If the head and tail KT lengths are different, the mapping start index may depend on the KT sequence in the beginning of the KT-DFT-s-OFDM symbol, while the mapping length may depend on the KT sequence in the end of the KT-DFT-s-OFDM symbol.

TABLE 1
Dependence of PTRS mapping on KT length.

| KT length | start index M_s | Mapping length |
|---|---|---|
| 8 | 8*X | M_sc − 8*2*X |
| 16 | 16*X | M_sc − 16*2*X |
| 32 | 32*X | M_sc − 32*2*X |

If the number of the PTRS groups N_{group}^{PTRS} and/or the number of PTRSs Nₛₐₘₚ^{group} in each PTRS group also depend on the KT length, for example, one of the following statements may hold:
the larger the KT length, the smaller N_{group}^{PTRS};
the larger the KT length, the smaller Nₛₐₘₚ^{group}.

Table 2 below shows how N_{group}^{PTRS} and Nₛₐₘₚ^{group} may depend on the KT length.

TABLE 2
Dependence of the number of PTRS groups and the
number of PTRSs in each PTRS group on KT length.

| KT length | N_{group}^{PTRS} | Nₛₐₘₚ^{group} |
|---|---|---|
| <16 | 8 | 4 |
| 16 . . . 64 | 6 | 4 |
| >64 | 4 | 2 |

Tables 3-1 and 3-2 below show how N_{group}^{PTRS} and Nₛₐₘₚ^{group} may depend on the KT length and different numbers of allocated PRBs.

TABLE 3-1
Dependence of the number of PTRS groups and the number of PTRSs
in each PTRS group on KT length in case of PRBs < 10.
# of PRBs < 10

| KT length | N_{group}^{PTRS} | N_{group}^{samp} |
|---|---|---|
| <16 | 6 | 2 |
| 16 . . . 64 | 4 | 2 |
| >64 | 2 | 2 |

TABLE 3-2
Dependence of the number of PTRS groups and the number of PTRSs
in each PTRS group on KT length in case of PRBs ≥ 10.
# of PRBs ≥ 10

| KT length | N_{group}^{PTRS} | Nₛₐₘₚ^{group} |
|---|---|---|
| <16 | 8 | 4 |
| 16 . . . 64 | 6 | 4 |
| >64 | 4 | 2 |

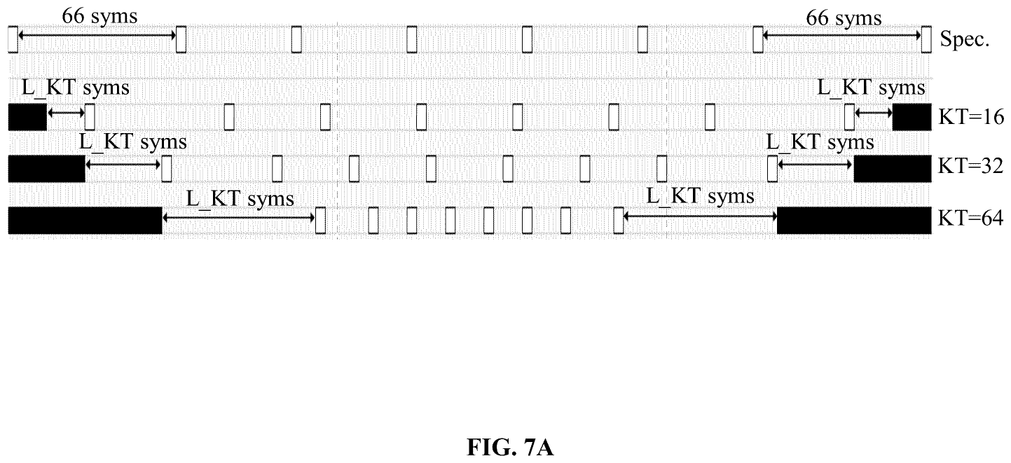

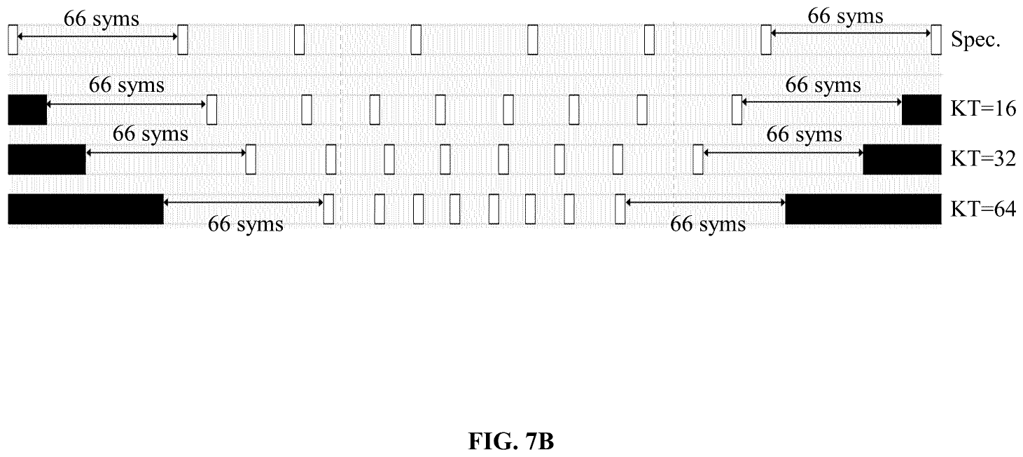

FIGS. 7A and 7B show different patterns of the PTRS mapping in case of using different lengths of the head and tail sequences of modulation symbols. At the same time, it is assumed that, in each case, the lengths of the head and tail sequences of modulation symbols are equal for simplicity. More specifically, the first (upper) pattern denoted by “Spec.” refers to the standard PTRS mapping within a DFT-s-OFDM symbol, while the patterns denoted by “KT=16”, “KT=32” and “KT=64” refer to the PTRS mapping within KT-DFT-s-OFDM symbols with different KT lengths (16, 32, and 64 modulation symbols). In these patterns, Nₛₐₘₚ^{group}=4, and N_{group}^{PT-RS}=8. Black coloured boxes denote the KT symbols, and white coloured boxes denote the PTRS groups. In the patterns “KT=16”, “KT=32” and “KT=64”, the mapping start index is set as L_KT*2 and the mapping length is set as M_sc-L_KT*4 (where L_KT is the number of modulation symbols occupied by the KT sequence). Unlike FIG. 7A, the distance between the KT sequence and the closest PTRS group is kept constant (i.e., 66 modulation symbols) in FIG. 7B.

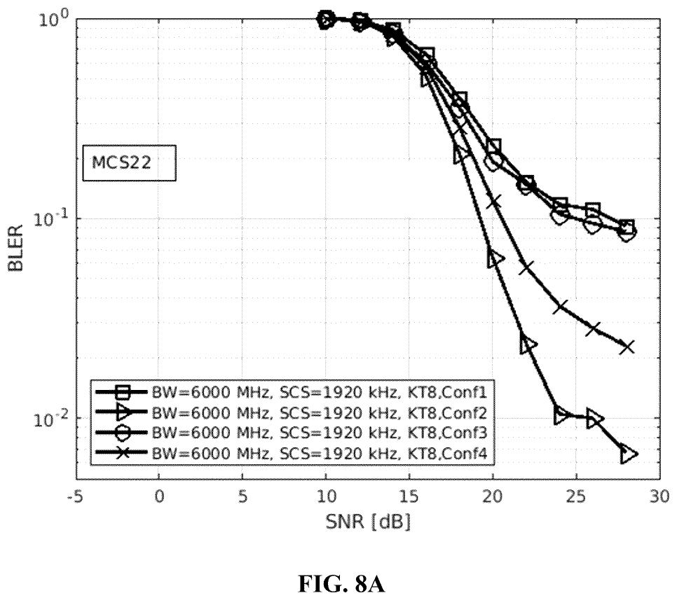

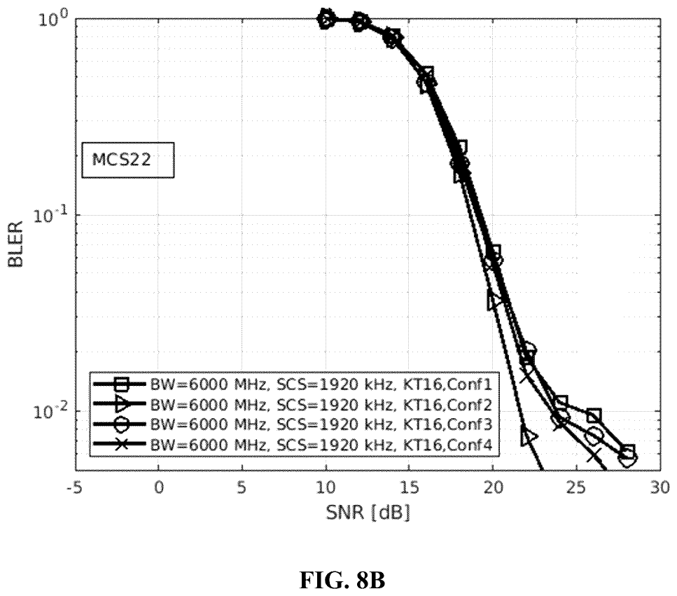

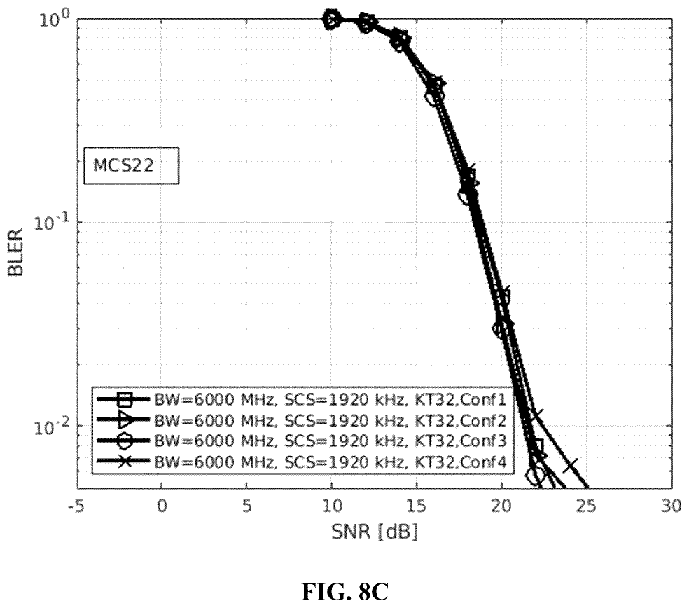

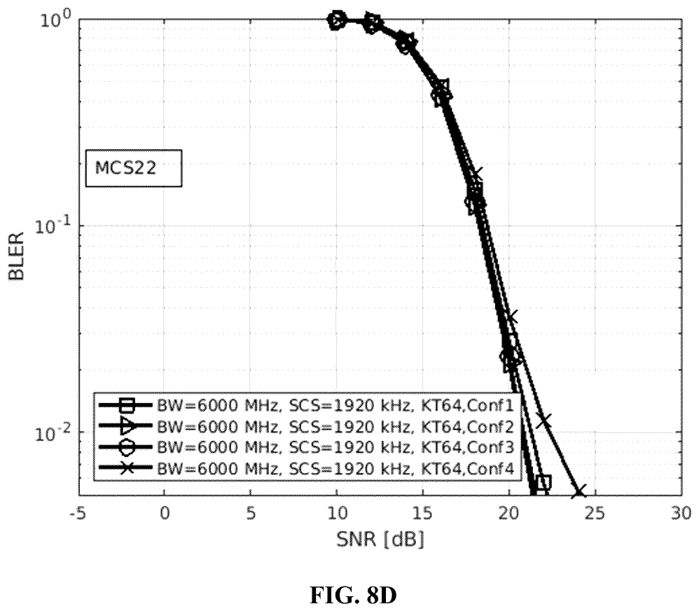

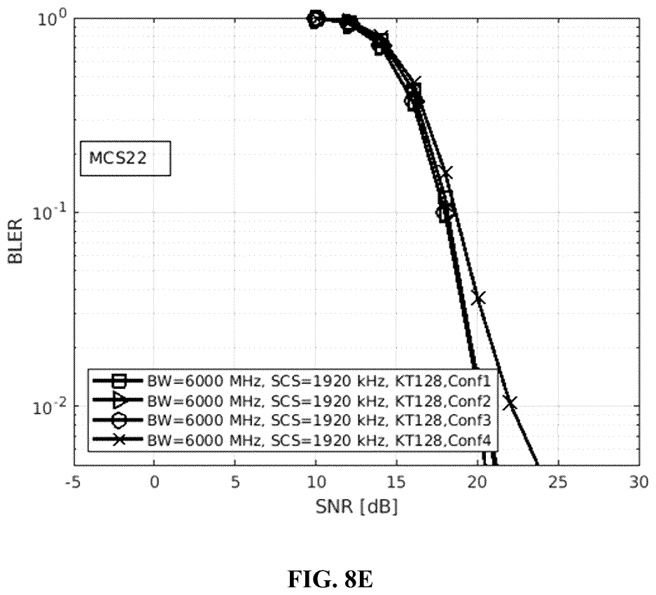

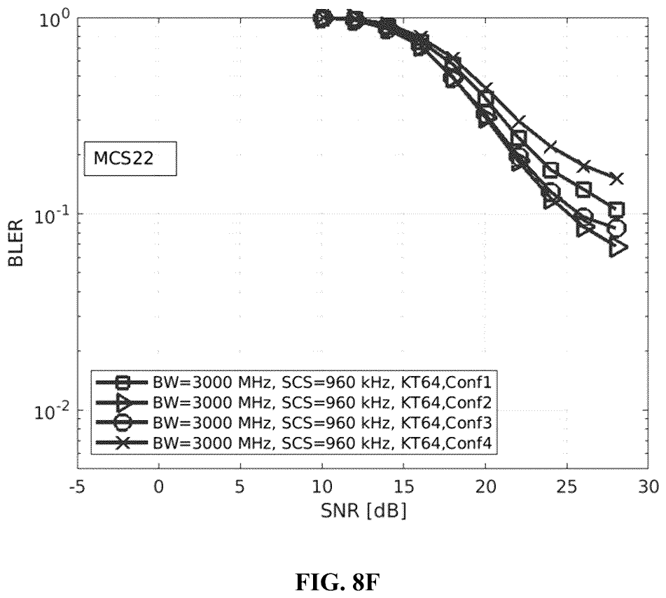

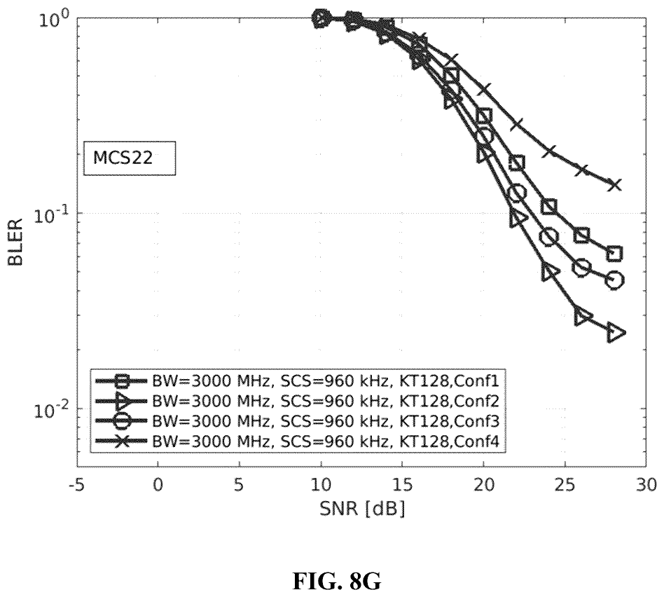

FIGS. 8A-8G show the comparative performance results of the legacy DFT-s-OFDM method and the method 400 at carrier frequency 140 GHZ, using 64 Quadrature Amplitude Modulation (QAM), subcarrier spacings 1920 kHz and 960 kHz, and different KT lengths (8, 16, 32, 64, and 128 symbols). In FIGS. 8A-8G, “MCS22” denotes a certain MCS selected from Table 5.1.3.1-1 (“MCS index table 1 for PDSCH”) in 3GPP TS38.214 (in particular, “MCS22” here means taking MCS index 22, i.e., it corresponds to 64QAM (modulation order 6) and a specific code rate).

As follows from FIG. 8A-8G, the comparative performance results are represented by the dependences of a Block Error Rate (BLER) on a Signal-to-Noise Ratio (SNR). The legends in FIGS. 8A-8G denote the following:
Conf1: the legacy DFT-s-OFDM method, in which the PTRS mapping is for the whole symbol and the mapping start index=0;
Conf2: one possible embodiment of the method 400, where the mapping start index and the mapping length are set as L_KT*2 and M_sc-L_KT*4, respectively;
Conf3: one other possible embodiment of the method 400, in which the mapping start index is at a fixed offset from the KT sequence, thereby leading to the fact that the distance between the KT sequence and the closest PTRS group is fixed independent of the KT length (as in FIG. 7B);
Conf4: one other possible embodiment of the method 400, in which the mapping starts right after the head KT sequence and ends right before the tail KT sequence, i.e., the mapping start index=L_KT and the mapping length=M_sc−L_KT*2.

One can observe that under each of the above experimental conditions, the configuration Conf2 gives the best performance, and considerable gains (e.g., when compared to the legacy Conf1) especially for smaller KT lengths. This clearly verifies the advantages of the method 400.

It should be noted that each step or operation of the methods 400 and 600, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 302 or 502, respectively. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1.-28. (canceled)

29. A User Equipment (UE) in a communication network, comprising:
at least one processor; and
at least one memory comprising a computer program code;
wherein the at least one memory and the computer program code are configured to, with the at least one processor, cause the UE to:
receive, from a network node, information that is indicative of: (i) a head sequence of modulation symbols to be appended to a head end of a single-carrier waveform symbol, and (ii) a tail sequence of modulation symbols to be appended to a tail end of the single-carrier waveform symbol;
based on a sequence length of at least one of the head sequence of modulation symbols and the tail sequence of modulation symbols, determine a Phase Tracking Reference Signal (PTRS) configuration that is indicative of how at least one PTRS symbol is to be mapped within the single-carrier waveform symbol; and
perform communications with the network node using the PTRS configuration.

30. The UE of claim 29, wherein the at least one memory and the computer program code are configured to, with the at least one processor, cause the UE to receive the information via a dedicated signalling.

31. The UE of claim 29, wherein the PTRS configuration is indicative of:
a mapping start point of the at least one PTRS symbol within the single-carrier waveform symbol; and
a mapping length of the at least one PTRS symbol within the single-carrier waveform symbol, the mapping length being calculated from the mapping start point.

32. The UE of claim 31, wherein the at least one memory and the computer program code are configured to, with the at least one processor, cause the UE to:
determine the mapping start point of the at least one PTRS symbol based on the sequence length of the head sequence of modulation symbols and determine the mapping length of the at least one PTRS symbol based on the sequence length of the tail sequence of modulation symbols; or
determine the mapping start point of the at least one PTRS symbol based on the sequence length of the tail sequence of modulation symbols and determine the mapping length of the at least one PTRS symbol based on the sequence length of the head sequence of modulation symbols.

33. The UE of claim 32, wherein the at least one memory and the computer program code are configured to, with the at least one processor, cause the UE to determine the mapping start point and the mapping length according to at least one of the following criteria:
the bigger the sequence length of the head sequence of modulation symbols, the farther the mapping start point of the at least one PTRS symbol is relative to the head end of each of the single-carrier waveform symbol; and
the bigger the sequence length of the tail sequence of modulation symbols, the shorter the mapping length of the at least one PTRS symbol.

34. The UE of claim 31, wherein the PTRS configuration is indicative of:
a number of PTRS groups into which the at least one PTRS symbol is to be divided within the single-carrier waveform symbol; and
a number of PTRS symbols in each of the PTRS groups, PTRS symbols being arranged consecutive in time in each of the PTRS groups.

35. The UE of claim 34, wherein the at least one memory and the computer program code are configured to, with the at least one processor, cause the UE to determine the number of the PTRS groups according to the following criterion:
the bigger the sequence length of at least one of the head sequence of modulation symbols and the tail sequence of the modulation symbols, the smaller the number of the PTRS groups into which the at least one PTRS symbol is to be divided within the single-carrier waveform symbol.

36. The UE of claim 34, wherein the at least one memory and the computer program code are configured to, with the at least one processor, cause the UE to determine the PTRS configuration according to at least one of the following criteria:
the bigger the sequence length of the head sequence of modulation symbols, the farther a first PTRS group of the PTRS groups is relative to the head end of the single-carrier waveform symbol; and
the bigger the sequence length of the tail sequence of modulation symbols, the farther a last PTRS group of the PTRS groups is relative to the tail end of the single-carrier waveform signal.

37. The UE of claim 29, wherein the sequence lengths of the head sequence of modulation symbols and the tail sequence of modulation symbols are equal.

38. The UE of claim 29, wherein the at least one memory and the computer program code are configured to, with the at least one processor, cause the UE to determine the PTRS configuration additionally based on at least one of:
a number of physical resource blocks dedicated to a communication channel established between the UE and the network node;
a Modulation and Coding Scheme (MCS) used by the UE for the communications;
a symbol length used in the communication channel; and
a subcarrier spacing applied for the communication channel.

39. The UE of claim 29, wherein the single-carrier waveform symbol comprises at least one Known Tail (KT) Discrete Fourier Transform (DFT) spread Orthogonal Frequency Division Multiplexing (OFDM) (KT-DFT-s-OFDM) symbol or at least one Single-Carrier Frequency Domain Equalization (SC-FDE) symbol.

40. The UE of claim 29, wherein the at least one memory further comprises:
a PTRS database comprising a plurality of database entries, each of the plurality of database entries being indicative of: (i) a PTRS configuration, and (ii) at least one of a head sequence of modulation symbols and a tail sequence of modulation symbols by which the PTRS configuration is determined; and
wherein the at least one memory and the computer program code are configured to, with the at least one processor, cause the UE to determine the PTRS configuration by selecting the PTRS configuration corresponding to the information from the PTRS database.

41. A network node in a communication network, comprising:
at least one processor; and
at least one memory comprising a computer program code;
wherein the at least one memory and the computer program code are configured to, with the at least one processor, cause the network node to:
transmit, to a User Equipment (UE), information that is indicative of: (i) a head sequence of modulation symbols to be appended to a head end of a single-carrier waveform symbol, and (ii) a tail sequence of modulation symbols to be appended to a tail end of the single-carrier waveform symbol, wherein the information causes the UE to determine a Phase Tracking Reference Signal (PTRS) configuration based on a sequence length of at least one of the head sequence of modulation symbols and the tail sequence of modulation symbols, the PTRS configuration being indicative of how at least one PTRS symbol is to be mapped within the single-carrier waveform symbol; and
perform communications with the UE using the PTRS configuration.

42. The network node of claim 41, wherein the at least one memory and the computer program code are configured to, with the at least one processor, cause the network node to transmit the information via a dedicated signalling.

43. The network node of claim 41, wherein the PTRS configuration is indicative of:
a mapping start point of the at least one PTRS symbol within the single-carrier waveform symbol;
a mapping length of the at least one PTRS symbol within the single-carrier waveform symbol, the mapping length being calculated from the mapping start point.

44. The network node of claim 43, wherein
the mapping start point of the at least one PTRS symbol is determined based on the sequence length of the head sequence of modulation symbols and the mapping length of the at least one PTRS symbol is determined based on the sequence length of the tail sequence of modulation symbols; or
the mapping start point of the at least one PTRS symbol is determined based on the sequence length of the tail sequence of modulation symbols and the mapping length of the at least one PTRS symbol is determined based on the sequence length of the head sequence of modulation symbols

45. The network node of claim 44, wherein the mapping start point and the mapping length are determined based on at least one of the following criteria:
the bigger the sequence length of the head sequence of modulation symbols, the farther the mapping start point of the at least one PTRS symbol is relative to the head end of the single-carrier waveform symbol; and
the bigger the sequence length of the tail sequence of modulation symbols, the shorter the mapping length of the at least one PTRS symbol.

46. The network node of claim 43, wherein the PTRS configuration is indicative of:
a number of PTRS groups into which the at least one PTRS symbol is to be divided within the single-carrier waveform symbol; and
a number of PTRS symbols in each of the PTRS groups, PTRS symbols being arranged consecutive in time in each of the PTRS groups.

47. The network node of claim 46, wherein the number of the PTRS groups is determined according to the following criterion:
the bigger the sequence length of at least one of the head sequence of modulation symbols and the tail sequence of the modulation symbols, the smaller the number of the PTRS groups into which the at least one PTRS symbol is to be divided within the single-carrier waveform symbol.

48. A method for operating a User Equipment (UE) in a communication network, comprising:
receiving, from a network node, information that is indicative of: (i) a head sequence of modulation symbols to be appended to a head end of a single-carrier waveform symbol, and (ii) a tail sequence of modulation symbols to be appended to a tail end of the single-carrier waveform symbol;
based on the sequence length of at least one of the head sequence of modulation symbols and the tail sequence of modulation symbols, determining a Phase Tracking Reference Signal (PTRS) configuration that is indicative of how at least one PTRS symbol is to be mapped within the single-carrier waveform symbol; and
performing communications with the network node using the PTRS configuration.
